(19) United States
(12) Patent Application Publication
(10) Pub. No.: US 2023/0219536 A1
(43) Pub. Date: Jul. 13, 2023

(54) ICE MELTING DEVICE

(71) Applicant: Qiana Bruce, Killeen, TX (US)

(72) Inventor: Qiana Bruce, Killeen, TX (US)

(21) Appl. No.: 17/574,351

(22) Filed: Jan. 12, 2022

(51) Int. Cl. B60S 3/04

(52) U.S. Cl. CPC B60S 3/04

(57) ABSTRACT

An ice melting device, including a pole, a heating assembly, including a base disposed on at least a portion of a first end of the pole, and a heating surface connected to the base to melt at least one of ice and snow disposed on at least one window of a vehicle in response to contact with the at least one of ice and snow, and a temperature gauge movably disposed on at least a portion of the base to adjust a temperature level of the heating surface based on at least one temperature setting of the temperature gauge.

### BACKGROUND

### 1. Field

The present general inventive concept relates generally to ice removal, and particularly, to an ice melting device.

### 2. Description of the Related Art

In areas that experience four seasons, winter is often one of the most difficult to experience. Cold temperatures, snow, and/or ice can create problems that are not encountered during the other three seasons of the year, such as icy roads, frozen pipes, and/or ice damage to a vehicle.

One of the most difficult tasks during the cold winter months is defrosting a windshield of the vehicle and/or exterior side windows. Most people apply physical labor by using an ice scraper and/or a shovel to gradually remove ice on the window. Unfortunately, this tedious process not only consumes a vast amount of time, but also expends a vehicle’s gas, since many people rely on the heat generated by the engine of the vehicle to aid the process. Furthermore, current de-icing methods such as ice scraping and shoveling have often left people with frozen fingers, as a result of long-term exposure to low temperatures.

Therefore, there is a need for an ice remover that does not require intense physical labor by scraping ice.

### SUMMARY

The present general inventive concept provides an ice melting device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an ice melting device, including a pole, a heating assembly, including a base disposed on at least a portion of a first end of the pole, and a heating surface connected to the base to melt at least one of ice and snow disposed on at least one window of a vehicle in response to contact with the at least one of ice and snow, and a temperature gauge movably disposed on at least a portion of the base to adjust a temperature level of the heating surface based on at least one temperature setting of the temperature gauge.

The pole may include a first section, and a second section movably disposed within at least a portion of the first section to telescopically move from within the first section in a first position to at least partially away from the first section in a second position, and move from away from the first section in the second position to within the first section in the first position.

The heating surface may use a mesh of heating coils to increase a temperature level thereof.

The ice melting device may further include a sensor disposed within at least a portion of the base to adjust the temperature level of the heating surface in response to detecting the at least one of ice and snow contacting the heating surface, such that the sensor automatically increases the temperature level of a first side of the heating surface in contact with the at least one of ice and snow to greater than the temperature level of a second side of the heating surface opposite with respect to the first side.

The ice melting device may further include a liquid receiving barrier disposed on at least a portion of the base to receive a liquid into the base and the heating surface, such that the temperature level of the heating surface changes based on changing a temperature level of the liquid.

The ice melting device may further include a handle disposed on a second end of the pole to facilitate gripping thereof and to adjust a length of the pole.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of an ice melting device, according to an exemplary embodiment of the present general inventive concept; and

FIG. 2 illustrates an isometric view of an ice melting device, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Ice Melting Device 100
Pole 110
First Section 111
Second Section 112
Heating Assembly 120
Heating Surface 121
First Edge 121a
Second Edge 121b
Base 122
Temperature Gauge 130
Sensor 140
Power Source 150
Charging Port 151
Handle 160
Pole Button 161
Heating Cover 170
Ice Melting Device 200
Pole 210
First Section 211
Second Section 212
Heating Assembly 220
Heating Surface 221
First Edge 221a
Second Edge 221b
Base 222
Temperature Gauge 230
Liquid Receiving Barrier 240
Power Source 250
Charging Port 251
Handle 260
Pole Button 261
Heating Cover 270

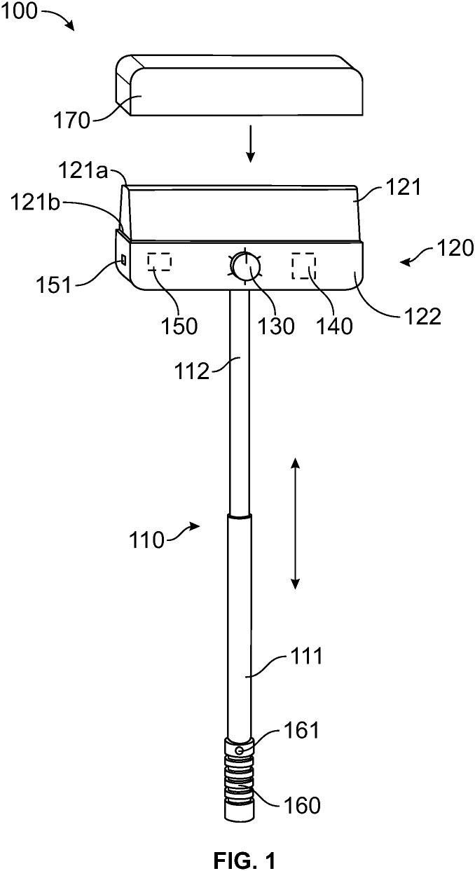

FIG. 1 illustrates a side perspective view of an ice melting device 100, according to an exemplary embodiment of the present general inventive concept.

The ice melting device 100 may be constructed from at least one of metal, plastic, wood, glass, and rubber, etc., but is not limited thereto.

The ice melting device 100 may include a pole 110, a heating assembly 120, a temperature gauge 130, a sensor 140, a power source 150, a handle 160, and a heating cover 170, but is not limited thereto.

The pole 110 may have a predetermined length corresponding to a width of a vehicle and/or a length of the vehicle. In other words, the length of the pole 110 may span a first distance equivalent to a length of a windshield. Alternatively, the length of the pole 110 may span a second distance equivalent to the length of the vehicle from a front of the vehicle to a rear of the vehicle.

The pole 110 may include a first section 111 and a second section 112, but is not limited thereto.

The second section 112 may be movably (i.e. slidably) disposed within at least a portion of the first section 111. More specifically, the second section 112 may telescopically move from within the first section 111 in a first position to at least partially away from the first section 111 in a second position. Conversely, the second section 112 may telescopically move from outside of the first section in the second position to at least partially within the first section in the first position. As such, the pole 110 may be adjustable in length to facilitate reaching other parts of a window.

The heating assembly 120 may include a heating surface 121 and a base 122, but is not limited thereto.

The heating surface 121 may have a mesh of heating coils disposed therein. The heating surface 121 may be a smooth surface and may be removably disposed and/or applied to at least one window and/or a windshield of the vehicle. Moreover, the heating surface 121 may melt ice and/or snow disposed on the at least one window and/or the windshield of the vehicle in response to contact with the ice and/or the snow. Accordingly, the heating surface 121 may reach a temperature level exceeding a melting point of the ice and/or the snow (e.g., 32° F. and/or 0° C.).

The heating surface 121 may include a first edge 121a and a second edge 121b, but is not limited thereto.

The heating surface 121 may have a triangular shape. Additionally, the first edge 121a may be disposed at a first end of the heating surface 121, and the second edge 121b may be disposed at a second end of the heating surface 121 opposite with respect to the first end of the heating surface 121. Also, the first edge 121a may be tapered with respect to the second edge 121b. In other words, a width of the first edge 121a may be less than a width of the second edge 121b, such that the heating surface 121 may taper from the second edge 121b toward the first edge 121a. It is important to note that the first edge 121a may have a rounded edge to prevent damage and/or scratching on the at least one window and/or the windshield of the vehicle while the first edge 121 contacts the at least one window and/or the windshield.

The base 122 may be disposed on at least a portion of the second section 112 on a first end of the pole 110 and/or connected to the heating surface 121. The base 122 may support the heating surface 121 thereon.

The temperature gauge 130 may be movably (i.e. rotatably) disposed on at least a portion of the base 122. The temperature gauge 130 may turn on the heating surface 121 in response to moving from off in a first position to at least partially toward at least one temperature setting in a second position. Moreover, the temperature level of the heating surface 121 may increase in response to moving the temperature gauge 130 in a first direction (i.e. clockwise) or a second direction (i.e. clockwise) from the first position to at least partially toward the at least one temperature setting in the second position. Conversely, the temperature level of the heating surface 121 may decrease in response to moving the temperature gauge 130 in the second direction or the first direction from the at least one temperature setting in the second position to at least partially toward off in the first position. As such, the temperature gauge 130 may adjust the temperature level of the heating surface 121 based on the at least one temperature setting. Thus, the ice and/or the snow may melt faster, for at least the reason, that the heating surface 121 may be adjusted to higher temperatures.

The sensor 140 may be disposed within at least a portion of the base 122. The sensor 140 may adjust at least a portion of the temperature level on the heating surface 121 in response to detecting the ice and/or the snow contacting the heating surface 121. More specifically, the temperature level on a first side of the heating surface 121 may automatically increase in response to the heating surface 121 contacting the ice and/or the snow, such that a second side of the heating surface 121 may remain at a lower temperature level with respect to the first side. In other words, the sensor 140 may increase the temperature level of the heating surface 121 based on a side of the heating surface 121 that is in need of more heat to melt the ice and/or the snow.

The power source 150 may include a charging port 151, but is not limited thereto.

Furthermore, the power source 150 may be constructed to have a battery and a solar cell, but is not limited thereto.

The power source 150 may be disposed within at least a portion of the base 122. The power source 150 may provide power to the heating assembly 120, the temperature gauge 130, and/or the sensor 140.

Additionally, the charging port 151 may be disposed on at least a portion of the base 122 and/or connected to the power source 150. The charging port 151 may receive and/or removably connect to an external power source, such as a charging cord connect to a power outlet. As such, the charging port 151 may facilitate charging of the power source 150.

The handle 160 may include a pole button 161, but is not limited thereto.

The handle 160 may be disposed on at least a portion of the first section 111 on a second end of the pole 110. The handle 160 may be ridged and/or have a textured surface (e.g., sandpaper) to facilitate gripping thereof.

The pole button 161 may be disposed on at least a portion of the handle 160 and/or connected to the second section 112 with a hydraulic rod. The pole button 161 may be disposed on at least a portion of the handle 160. The second section 112 may telescopically move from within the first section 111 in the first position to at least partially away from the first section 111 in the second position in response to depressing the pole button 161. Conversely, the second section 112 may telescopically move from outside of the first section 111 in the second position to at least partially within the first section 111 in the first position in response to an application of force thereto.

The heating cover 170 may be removably connected to at least a portion of the heating surface 121 and/or the base 122. The heating cover 170 may cover the heating surface 121 during storage.

Therefore, the ice melting device 100 may facilitate removal of the ice and/or the snow disposed on the at least one window or the windshield of the vehicle. Thus, the ice melting device 100 may reduce a period of time to remove the ice and/or the snow due to using heat.

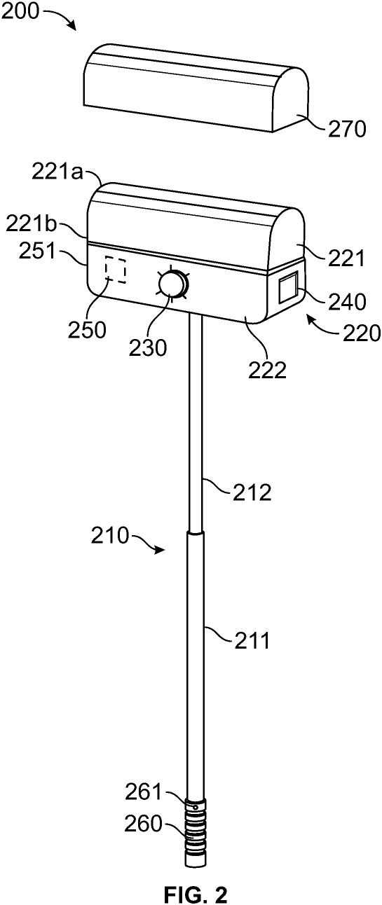

FIG. 2 illustrates an isometric view of an ice melting device 200, according to another exemplary embodiment of the present general inventive concept.

The ice melting device 200 may be constructed from at least one of metal, plastic, wood, glass, and rubber, etc., but is not limited thereto.

The ice melting device 200 may include a pole 210, a heating assembly 220, a temperature gauge 230, a liquid receiving barrier 240, a power source 250, a handle 260, and a heating cover 270, but is not limited thereto.

The pole 210 may have a predetermined length corresponding to a width of a vehicle and/or a length of the vehicle. In other words, the length of the pole 210 may span a first distance equivalent to a length of a windshield. Alternatively, the length of the pole 210 may span a second distance equivalent to the length of the vehicle from a front of the vehicle to a rear of the vehicle.

The pole 210 may include a first section 211 and a second section 212, but is not limited thereto.

The second section 212 may be movably (i.e. slidably) disposed within at least a portion of the first section 211. More specifically, the second section 212 may telescopically move from within the first section 211 in a first position to at least partially away from the first section 211 in a second position. Conversely, the second section 212 may telescopically move from outside of the first section in the second position to at least partially within the first section in the first position. As such, the pole 210 may be adjustable in length to facilitate reaching other parts of a window.

The heating assembly 220 may include a heating surface 221 and a base 222, but is not limited thereto.

The heating surface 221 may have a mesh of heating coils disposed therein. The heating surface 221 may be a smooth surface and may be removably disposed and/or applied to at least one window and/or a windshield of the vehicle. Moreover, the heating surface 221 may melt ice and/or snow disposed on the at least one window and/or the windshield of the vehicle in response to contact with the ice and/or the snow. Accordingly, the heating surface 221 may reach a temperature level exceeding a melting point of the ice and/or the snow (e.g., 32° F. and/or 0° C.).

The heating surface 221 may include a first edge 221a and a second edge 221b, but is not limited thereto.

The heating surface 221 may have a convex shape. Additionally, the first edge 221a may be disposed at a first end of the heating surface 221, and the second edge 121b may be disposed at a second end of the heating surface 221 opposite with respect to the first end of the heating surface 221. Also, the first edge 221a may be curved with respect to the second edge 221b. In other words, the first edge 221a may be rounded and the second edge 221b may be planar (i.e., flat). It is important to note that the first edge 221a may be rounded to prevent damage and/or scratching on the at least one window and/or the windshield of the vehicle while the first edge 221 contacts the at least one window and/or the windshield.

The base 222 may be disposed on at least a portion of the second section 212 on a first end of the pole 210 and/or connected to the heating surface 221. The base 222 may support the heating surface 221 thereon.

The temperature gauge 230 may be movably (i.e. rotatably) disposed on at least a portion of the base 222. The temperature gauge 230 may turn on the heating surface 221 in response to moving from off in a first position to at least partially toward at least one temperature setting in a second position. Moreover, the temperature level of the heating surface 221 may increase in response to moving the temperature gauge 230 in a first direction (i.e. clockwise) or a second direction (i.e. clockwise) from the first position to at least partially toward the at least one temperature setting in the second position. Conversely, the temperature level of the heating surface 221 may decrease in response to moving the temperature gauge 230 in the second direction or the first direction from the at least one temperature setting in the second position to at least partially toward off in the first position. As such, the temperature gauge 230 may adjust the temperature level of the heating surface 221 based on the at least one temperature setting. Thus, the ice and/or the snow may melt faster, for at least the reason, that the heating surface 221 may be adjusted to higher temperatures.

The liquid receiving barrier 240 may be disposed on at least a portion of the base 222. The liquid receiving barrier 240 may open to receive a liquid (e.g., water) within the heating surface 221 and/or the base 222. The mesh of heating coils within the heating surface 221 may adjust at least a portion of the temperature level on the heating surface 121 by changing a temperature level of the liquid therein. In other words, the temperature gauge 230 may increase and/or decrease the temperature level of the water within the heating surface 221, such that the temperature level of the heating surface 221 may increase and/or decrease in response to the change in the temperature level of the water.

The power source 250 may include a charging port 251, but is not limited thereto.

Furthermore, the power source 250 may be constructed to have a battery and a solar cell, but is not limited thereto.

The power source 250 may be disposed within at least a portion of the base 222. The power source 250 may provide power to the heating assembly 220 and/or the temperature gauge 230.

Additionally, the charging port 251 may be disposed on at least a portion of the base 222 and/or connected to the power source 250. The charging port 251 may receive and/or removably connect to an external power source, such as a charging cord connect to a power outlet. As such, the charging port 251 may facilitate charging of the power source 250.

The handle 260 may include a pole button 261, but is not limited thereto.

The handle 260 may be disposed on at least a portion of the first section 211 on a second end of the pole 210. The handle 260 may be ridged and/or have a textured surface (e.g., sandpaper) to facilitate gripping thereof.

The pole button 261 may be disposed on at least a portion of the handle 260 and/or connected to the second section 212 with a hydraulic rod. The pole button 261 may be disposed on at least a portion of the handle 260. The second section 212 may telescopically move from within the first section 211 in the first position to at least partially away from the first section 211 in the second position in response to depressing the pole button 261. Conversely, the second section 212 may telescopically move from outside of the first section 211 in the second position to at least partially within the first section 211 in the first position in response to an application of force thereto.

The heating cover 270 may be removably connected to at least a portion of the heating surface 221 and/or the base 222. The heating cover 270 may cover the heating surface 221 during storage.

Therefore, the ice melting device 200 may facilitate removal of the ice and/or the snow disposed on the at least one window or the windshield of the vehicle. Thus, the ice melting device 200 may reduce a period of time to remove the ice and/or the snow due to using heat.

The present general inventive concept may include an ice melting device 100, including a pole 110, a heating assembly 120, including a base 122 disposed on at least a portion of a first end of the pole 110, and a heating surface 121 connected to the base 122 to melt at least one of ice and snow disposed on at least one window of a vehicle in response to contact with the at least one of ice and snow, and a temperature gauge 130 movably disposed on at least a portion of the base 122 to adjust a temperature level of the heating surface 121 based on at least one temperature setting of the temperature gauge 130.

The pole 110 may include a first section 111, and a second section 112 movably disposed within at least a portion of the first section 111 to telescopically move from within the first section 111 in a first position to at least partially away from the first section 111 in a second position, and move from away from the first section 111 in the second position to within the first section 111 in the first position.

The heating surface 121 may use a mesh of heating coils to increase a temperature level thereof.

The ice melting device 100 may further include a sensor 140 disposed within at least a portion of the base 122 to adjust the temperature level of the heating surface 121 in response to detecting the at least one of ice and snow contacting the heating surface 121, such that the sensor 140 automatically increases the temperature level of a first side of the heating surface 121 in contact with the at least one of ice and snow to greater than the temperature level of a second side of the heating surface 121 opposite with respect to the first side.

The ice melting device 200 may further include a liquid receiving barrier 240 disposed on at least a portion of the base 222 to receive a liquid into the base 222 and the heating surface 221, such that the temperature level of the heating surface 221 changes based on changing a temperature level of the liquid.

The ice melting device 100 may further include a handle 160 disposed on a second end of the pole 110 to facilitate gripping thereof and to adjust a length of the pole 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An ice melting device, comprising:
a pole;
a heating assembly, comprising:
a base disposed on at least a portion of a first end of the pole, and
a heating surface connected to the base to melt at least one of ice and snow disposed on at least one window of a vehicle in response to contact with the at least one of ice and snow; and
a temperature gauge movably disposed on at least a portion of the base to adjust a temperature level of the heating surface based on at least one temperature setting of the temperature gauge.

2. The ice melting device of claim 1, wherein the pole comprises:
a first section; and
a second section movably disposed within at least a portion of the first section to telescopically move from within the first section in a first position to at least partially away from the first section in a second position, and move from away from the first section in the second position to within the first section in the first position.

3. The ice melting device of claim 1, wherein the heating surface uses a mesh of heating coils to increase a temperature level thereof.

4. The ice melting device of claim 1, further comprising:
a sensor disposed within at least a portion of the base to adjust the temperature level of the heating surface in response to detecting the at least one of ice and snow contacting the heating surface, such that the sensor automatically increases the temperature level of a first side of the heating surface in contact with the at least one of ice and snow to greater than the temperature level of a second side of the heating surface opposite with respect to the first side.

5. The ice melting device of claim 1, further comprising:
a liquid receiving barrier disposed on at least a portion of the base to receive a liquid into the base and the heating surface, such that the temperature level of the heating surface changes based on changing a temperature level of the liquid.

6. The ice melting device of claim 1, further comprising:
a handle disposed on a second end of the pole to facilitate gripping thereof and to adjust a length of the pole.
